(19) United States
(12) Patent Application Publication
(10) Pub. No.: US 2026/0281167 A1
(43) Pub. Date: Sep. 17, 2026

(54) ELECTRONIC DEVICE AND METHOD FOR BLOCKING CALL

(71) Applicant: SAMSUNG ELECTRONICS CO., LTD., Suwon-si (KR)

(72) Inventors: Jinseong AHN, Suwon-si (KR); Byoungki YOU, Suwon-si (KR); Kiyong LEE, Suwon-si (KR)

(21) Appl. No.: 19/669,712

(22) Filed: May 6, 2026

Related U.S. Application Data
(63) Continuation of application No. PCT/KR2024/017486, filed on Nov. 7, 2024.

(30) Foreign Application Priority Data
Nov. 28, 2023 (KR) 10-2023-0167725
Dec. 21, 2023 (KR) 10-2023-0188253

(51) Int. Cl. H04L 65/1076; H04L 65/1016; H04L 65/1096; H04M 3/42; H04M 3/436

(52) U.S. Cl. CPC H04L 65/1076; H04L 65/1016; H04L 65/1096; H04M 3/42059; H04M 3/436

(57) ABSTRACT

An electronic device may include a processor, and a memory for storing instructions. When the instructions are executed by the processor(s), the electronic device can control that: a list of blocked call numbers is stored; a phone number related to a first message is identified on the basis of the first message for call reception being received; whether the phone number related to the first message is included in the list of blocked call numbers is identified; and, on the basis of the phone number related to the first message being included in the list of blocked call numbers, a second message for rejecting call reception is transmitted to an external device in a state in which at least one of operations for call connection is not performed.

### CROSS-REFERENCE TO RELATED APPLICATIONS

This application is a continuation application of International Application No. PCT/KR2024/017486 designating the United States, filed on Nov. 7, 2024, in the Korean Intellectual Property Receiving Office and claiming priority to Korean Patent Application No. 10-2023-0167725, filed on Nov. 28, 2023, and Korean Patent Application No. 10-2023-0188253, filed on Dec. 21, 2023, the disclosures of which are all hereby incorporated by reference herein in their entireties.

### TECHNICAL FIELD

Certain example embodiments may relate to an electronic device, and for example, to an electronic device and/or a method thereof for performing call connection and/or call blocking. The electronic device may include a mobile communication terminal.

### BACKGROUND

A wireless communication system may provide wireless communication of an electronic device to guarantee mobility (or activity) of a user possessing the electronic device. For example, the wireless communication may include a communication technology in which a transmitting device and a receiving device transmit and/or receive a signal (or data) through wireless resources (e.g., frequency and/or time). The wireless communication system is expanding its scope to not only voice services but also data services.

Due to an increase in a penetration rate of the mobile communication terminal, the mobile communication terminal has now established itself as a daily necessity for modern people. Such a mobile communication terminal has become able to provide not only inherent voice call services but also various data transmission services and various additional services, and thus has been transformed into a multimedia communication device in terms of functions.

A call blocking function may be included in the mobile communication terminal. Recently, various additional functions such as, in a case where a calling number is a blocked number preset in a receiving terminal, an incoming call is automatically blocked without a call of a recipient, are being provided to the mobile communication terminal.

A receiving terminal may identify that a call is received from a sending terminal by receiving ‘INVITE’, which is a session initiation protocol (SIP) message. The receiving terminal may receive the SIP message at an IP multimedia subsystem (IMS) layer and transmit call-related messages (e.g., 100 Trying, 183 Session Progress, 180 Ringing). In the process, the receiving terminal may transmit information on call reception or an incoming call to an application related to the call.

The receiving terminal may transmit the information on the incoming call to the application related to the call and be allocated a bearer for communication. The application may identify whether it is a number blocked by a user based on the incoming call information. The application, in a case where a receiving number is the blocked number, may transmit a response for rejection to the IMS layer without notifying the user of an incoming call.

The IMS layer may receive the response for rejection from the application related to the call and transmit a message related to reception reject (e.g., 486 Reject) to the sending terminal. In this case, for the call to be eventually rejected, the receiving terminal transmits the call-related messages (e.g., 100Trying, 183 Session Progress, 180 Ringing) and is allocated the bearer for communication, and thus resource waste may occur.

An electronic device may include a processor (including one or more processors, each including processing circuitry) and a memory storing instructions. The instructions, when executed individually and/or collectively by the processor (one or more processors), may cause the electronic device to store a blocked number list, to identify a phone number related to a first message based on reception of the first message for an incoming call, to identify whether the phone number related to the first message is included in the blocked number list, and to transmit a second message rejecting the incoming call to an external device in a state in which at least any one operation among operations for call connection is not performed, based on the phone number related to the first message being included in the blocked number list.

In an operating method, the operating method may include storing a blocked number list; identifying a phone number related to a first message based on reception of the first message for an incoming call; identifying whether the phone number related to the first message is included in the blocked number list; and transmitting a second message rejecting the incoming call to an external device in a state in which at least any one operation among operations for a call connection is not performed, based on the phone number related to the first message being included in the blocked number list.

A storage medium may or may not include a processor and may include a memory in which a blocked number list is stored, where the memory stores instructions, and the instructions, when executed by the processor (the processor may include one or more processors), may cause the electronic device to store the blocked number list, to identify a phone number related to a first message based on reception of the first message for an incoming call, to identify whether the phone number related to the first message is included in the blocked number list, and to transmit a second message rejecting the incoming call to an external device in a state in which at least any one operation among operations for call connection is not performed, based on the phone number related to the first message being included in the blocked number list.

An electronic device and the operating method according to an example embodiment, when a call is received from a blocked number, may prevent or reduce resource waste by transmitting a rejection message without transmitting call-related messages (e.g., 100Trying, 183 Session Progress, 180 Ringing) or being allocated a bearer for communication.

The electronic device and the operating method may prevent or reduce resource waste by not only identifying a blocked number list in an application related to the call but also identifying the blocked number list at an IMS layer of a receiving terminal.

### BRIEF DESCRIPTION OF DRAWINGS

FIG. 1 is a block diagram of an electronic device in a network environment according to various example embodiments.

FIG. 2A illustrates a process in which an electronic device in a network environment according to a comparative embodiment establishes a call connection with an external device.

FIG. 2B illustrates a process in which an electronic device in a network environment according to a comparative embodiment blocks a call connection with an external device.

FIG. 3 illustrates a configuration of an electronic device according to an example embodiment as a block diagram.

FIG. 4 illustrates a process in which an electronic device according to various example embodiments blocks a call connection with an external device.

FIG. 5 illustrates a method in which an electronic device according to an example embodiment blocks a call connection with an external device as a flowchart.

FIG. 6 illustrates an operation in which an electronic device according to an example embodiment blocks a call connection with an external device as a flowchart.

FIGS. 7A and 7B illustrate an embodiment in which an electronic device according to an example embodiment blocks a call connection with an external device and displays it to a user.

### DETAILED DESCRIPTION

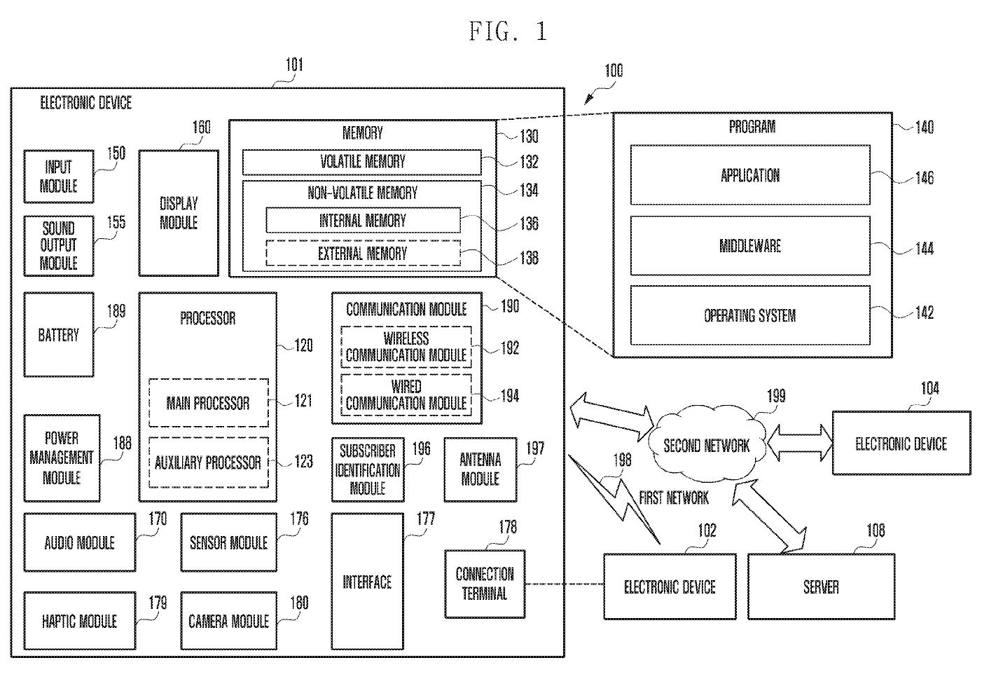

FIG. 1 is a block diagram illustrating an electronic device 101 in a network environment 100 according to various embodiments. Referring to FIG. 1, the electronic device 101 in the network environment 100 may communicate with an electronic device 102 via a first network 198 (e.g., a short-range wireless communication network), or at least one of an electronic device 104 or a server 108 via a second network 199 (e.g., a long-range wireless communication network). According to an embodiment, the electronic device 101 may communicate with the electronic device 104 via the server 108. According to an embodiment, the electronic device 101 may include a processor 120, memory 130, an input module 150, a sound output module 155, a display module 160, an audio module 170, a sensor module 176, an interface 177, a connecting terminal 178, a haptic module 179, a camera module 180, a power management module 188, a battery 189, a communication module 190, a subscriber identification module(SIM) 196, or an antenna module 197. In some embodiments, at least one of the components (e.g., the connecting terminal 178) may be omitted from the electronic device 101, or one or more other components may be added in the electronic device 101. In some embodiments, some of the components (e.g., the sensor module 176, the camera module 180, or the antenna module 197) may be implemented as a single component (e.g., the display module 160).

The processor 120 may execute, for example, software (e.g., a program 140) to control at least one other component (e.g., a hardware or software component) of the electronic device 101 coupled with the processor 120, and may perform various data processing or computation. According to one embodiment, as at least part of the data processing or computation, the processor 120 may store a command or data received from another component (e.g., the sensor module 176 or the communication module 190) in volatile memory 132, process the command or the data stored in the volatile memory 132, and store resulting data in non-volatile memory 134. According to an embodiment, the processor 120 may include a main processor 121 (e.g., a central processing unit (CPU) or an application processor (AP)), or an auxiliary processor 123 (e.g., a graphics processing unit (GPU), a neural processing unit (NPU), an image signal processor (ISP), a sensor hub processor, or a communication processor (CP)) that is operable independently from, or in conjunction with, the main processor 121. For example, when the electronic device 101 includes the main processor 121 and the auxiliary processor 123, the auxiliary processor 123 may be adapted to consume less power than the main processor 121, or to be specific to a specified function. The auxiliary processor 123 may be implemented as separate from, or as part of the main processor 121.

The auxiliary processor 123 may control at least some of functions or states related to at least one component (e.g., the display module 160, the sensor module 176, or the communication module 190) among the components of the electronic device 101, instead of the main processor 121 while the main processor 121 is in an inactive (e.g., sleep) state, or together with the main processor 121 while the main processor 121 is in an active state (e.g., executing an application). According to an embodiment, the auxiliary processor 123 (e.g., an image signal processor or a communication processor) may be implemented as part of another component (e.g., the camera module 180 or the communication module 190) functionally related to the auxiliary processor 123. According to an embodiment, the auxiliary processor 123 (e.g., the neural processing unit) may include a hardware structure specified for artificial intelligence model processing. An artificial intelligence model may be generated by machine learning. Such learning may be performed, e.g., by the electronic device 101 where the artificial intelligence is performed or via a separate server (e.g., the server 108). Learning algorithms may include, but are not limited to, e.g., supervised learning, unsupervised learning, semi-supervised learning, or reinforcement learning. The artificial intelligence model may include a plurality of artificial neural network layers. The artificial neural network may be a deep neural network (DNN), a convolutional neural network (CNN), a recurrent neural network (RNN), a restricted boltzmann machine (RBM), a deep belief network (DBN), a bidirectional recurrent deep neural network (BRDNN), deep Q-network or a combination of two or more thereof but is not limited thereto. The artificial intelligence model may, additionally or alternatively, include a software structure other than the hardware structure.

The memory 130 may store various data used by at least one component (e.g., the processor 120 or the sensor module 176) of the electronic device 101. The various data may include, for example, software (e.g., the program 140) and input data or output data for a command related thererto. The memory 130 may include the volatile memory 132 or the non-volatile memory 134.

The program 140 may be stored in the memory 130 as software, and may include, for example, an operating system (OS) 142, middleware 144, or an application 146.

The input module 150 may receive a command or data to be used by another component (e.g., the processor 120) of the electronic device 101, from the outside (e.g., a user) of the electronic device 101. The input module 150 may include, for example, a microphone, a mouse, a keyboard, a key (e.g., a button), or a digital pen (e.g., a stylus pen).

The sound output module 155 may output sound signals to the outside of the electronic device 101. The sound output module 155 may include, for example, a speaker or a receiver. The speaker may be used for general purposes, such as playing multimedia or playing record. The receiver may be used for receiving incoming calls. According to an embodiment, the receiver may be implemented as separate from, or as part of the speaker.

The display module 160 may visually provide information to the outside (e.g., a user) of the electronic device 101. The display module 160 may include, for example, a display, a hologram device, or a projector and control circuitry to control a corresponding one of the display, hologram device, and projector. According to an embodiment, the display module 160 may include a touch sensor adapted to detect a touch, or a pressure sensor adapted to measure the intensity of force incurred by the touch.

The audio module 170 may convert a sound into an electrical signal and vice versa. According to an embodiment, the audio module 170 may obtain the sound via the input module 150, or output the sound via the sound output module 155 or a headphone of an external electronic device (e.g., an electronic device 102) directly (e.g., wiredly) or wirelessly coupled with the electronic device 101.

The sensor module 176 may detect an operational state (e.g., power or temperature) of the electronic device 101 or an environmental state (e.g., a state of a user) external to the electronic device 101, and then generate an electrical signal or data value corresponding to the detected state. According to an embodiment, the sensor module 176 may include, for example, a gesture sensor, a gyro sensor, an atmospheric pressure sensor, a magnetic sensor, an acceleration sensor, a grip sensor, a proximity sensor, a color sensor, an infrared (IR) sensor, a biometric sensor, a temperature sensor, a humidity sensor, or an illuminance sensor.

The interface 177 may support one or more specified protocols to be used for the electronic device 101 to be coupled with the external electronic device (e.g., the electronic device 102) directly (e.g., wiredly) or wirelessly. According to an embodiment, the interface 177 may include, for example, a high definition multimedia interface (HDMI), a universal serial bus (USB) interface, a secure digital (SD) card interface, or an audio interface.

A connecting terminal 178 may include a connector via which the electronic device 101 may be physically connected with the external electronic device (e.g., the electronic device 102). According to an embodiment, the connecting terminal 178 may include, for example, a HDMI connector, a USB connector, a SD card connector, or an audio connector (e.g., a headphone connector).

The haptic module 179 may convert an electrical signal into a mechanical stimulus (e.g., a vibration or a movement) or electrical stimulus which may be recognized by a user via his tactile sensation or kinesthetic sensation. According to an embodiment, the haptic module 179 may include, for example, a motor, a piezoelectric element, or an electric stimulator.

The camera module 180 may capture a still image or moving images. According to an embodiment, the camera module 180 may include one or more lenses, image sensors, image signal processors, or flashes.

The power management module 188 may manage power supplied to the electronic device 101. According to one embodiment, the power management module 188 may be implemented as at least part of, for example, a power management integrated circuit (PMIC).

The battery 189 may supply power to at least one component of the electronic device 101. According to an embodiment, the battery 189 may include, for example, a primary cell which is not rechargeable, a secondary cell which is rechargeable, or a fuel cell.

The communication module 190 may support establishing a direct (e.g., wired) communication channel or a wireless communication channel between the electronic device 101 and the external electronic device (e.g., the electronic device 102, the electronic device 104, or the server 108) and performing communication via the established communication channel. The communication module 190 may include one or more communication processors that are operable independently from the processor 120 (e.g., the application processor (AP)) and supports a direct (e.g., wired) communication or a wireless communication. According to an embodiment, the communication module 190 may include a wireless communication module 192 (e.g., a cellular communication module, a short-range wireless communication module, or a global navigation satellite system (GNSS) communication module) or a wired communication module 194 (e.g., a local area network (LAN) communication module or a power line communication (PLC) module). A corresponding one of these communication modules may communicate with the external electronic device via the first network 198 (e.g., a short-range communication network, such as BluetoothTM, wireless-fidelity (Wi-Fi) direct, or infrared data association (IrDA)) or the second network 199 (e.g., a long-range communication network, such as a legacy cellular network, a 5G network, a next-generation communication network, the Internet, or a computer network (e.g., LAN or wide area network (WAN)). These various types of communication modules may be implemented as a single component (e.g., a single chip), or may be implemented as multi components (e.g., multi chips) separate from each other. The wireless communication module 192 may identify and authenticate the electronic device 101 in a communication network, such as the first network 198 or the second network 199, using subscriber information (e.g., international mobile subscriber identity (IMSI)) stored in the subscriber identification module 196.

The wireless communication module 192 may support a 5G network, after a 4G network, and next-generation communication technology, e.g., new radio (NR) access technology. The NR access technology may support enhanced mobile broadband (eMBB), massive machine type communications (mMTC), or ultra-reliable and low-latency communications (URLLC). The wireless communication module 192 may support a high-frequency band (e.g., the mmWave band) to achieve, e.g., a high data transmission rate. The wireless communication module 192 may support various technologies for securing performance on a high-frequency band, such as, e.g., beamforming, massive multiple-input and multiple-output (massive MIMO), full dimensional MIMO (FD-MIMO), array antenna, analog beam-forming, or large scale antenna. The wireless communication module 192 may support various requirements specified in the electronic device 101, an external electronic device (e.g., the electronic device 104), or a network system (e.g., the second network 199). According to an embodiment, the wireless communication module 192 may support a peak data rate (e.g., 20Gbps or more) for implementing eMBB, loss coverage (e.g., 164dB or less) for implementing mMTC, or U-plane latency (e.g., 0.5ms or less for each of downlink (DL) and uplink (UL), or a round trip of 1ms or less) for implementing URLLC.

The antenna module 197 may transmit or receive a signal or power to or from the outside (e.g., the external electronic device) of the electronic device 101. According to an embodiment, the antenna module 197 may include an antenna including a radiating element composed of a conductive material or a conductive pattern formed in or on a substrate (e.g., a printed circuit board (PCB)). According to an embodiment, the antenna module 197 may include a plurality of antennas (e.g., array antennas). In such a case, at least one antenna appropriate for a communication scheme used in the communication network, such as the first network 198 or the second network 199, may be selected, for example, by the communication module 190 (e.g., the wireless communication module 192) from the plurality of antennas. The signal or the power may then be transmitted or received between the communication module 190 and the external electronic device via the selected at least one antenna. According to an embodiment, another component (e.g., a radio frequency integrated circuit (RFIC)) other than the radiating element may be additionally formed as part of the antenna module 197.

According to various embodiments, the antenna module 197 may form a mmWave antenna module. According to an embodiment, the mmWave antenna module may include a printed circuit board, a RFIC disposed on a first surface (e.g., the bottom surface) of the printed circuit board, or adjacent to the first surface and capable of supporting a designated high-frequency band (e.g., the mmWave band), and a plurality of antennas (e.g., array antennas) disposed on a second surface (e.g., the top or a side surface) of the printed circuit board, or adjacent to the second surface and capable of transmitting or receiving signals of the designated high-frequency band.

At least some of the above-described components may be coupled mutually and communicate signals (e.g., commands or data) therebetween via an inter-peripheral communication scheme (e.g., a bus, general purpose input and output (GPIO), serial peripheral interface (SPI), or mobile industry processor interface (MIPI)).

According to an embodiment, commands or data may be transmitted or received between the electronic device 101 and the external electronic device 104 via the server 108 coupled with the second network 199. Each of the electronic devices 102 or 104 may be a device of a same type as, or a different type, from the electronic device 101. According to an embodiment, all or some of operations to be executed at the electronic device 101 may be executed at one or more of the external electronic devices 102, 104, or 108. For example, if the electronic device 101 should perform a function or a service automatically, or in response to a request from a user or another device, the electronic device 101, instead of, or in addition to, executing the function or the service, may request the one or more external electronic devices to perform at least part of the function or the service. The one or more external electronic devices receiving the request may perform the at least part of the function or the service requested, or an additional function or an additional service related to the request, and transfer an outcome of the performing to the electronic device 101. The electronic device 101 may provide the outcome, with or without further processing of the outcome, as at least part of a reply to the request. To that end, a cloud computing, distributed computing, mobile edge computing (MEC), or client-server computing technology may be used, for example. The electronic device 101 may provide ultra low-latency services using, e.g., distributed computing or mobile edge computing. In another embodiment, the external electronic device 104 may include an internet-of-things (IoT) device. The server 108 may be an intelligent server using machine learning and/or a neural network. According to an embodiment, the external electronic device 104 or the server 108 may be included in the second network 199. The electronic device 101 may be applied to intelligent services (e.g., smart home, smart city, smart car, or healthcare) based on 5G communication technology or IoT-related technology.

The electronic device according to various embodiments may be one of various types of electronic devices. The electronic devices may include, for example, a portable communication device (e.g., a smartphone), a computer device, a portable multimedia device, a portable medical device, a camera, a wearable device, or a home appliance. According to an embodiment of the disclosure, the electronic devices are not limited to those described above.

It should be appreciated that various embodiments of the present disclosure and the terms used therein are not intended to limit the technological features set forth herein to particular embodiments and include various changes, equivalents, or replacements for a corresponding embodiment. With regard to the description of the drawings, similar reference numerals may be used to refer to similar or related elements. It is to be understood that a singular form of a noun corresponding to an item may include one or more of the things, unless the relevant context clearly indicates otherwise. As used herein, each of such phrases as "A or B," "at least one of A and B," "at least one of A or B," "A, B, or C," "at least one of A, B, and C," and "at least one of A, B, or C," may include any one of, or all possible combinations of the items enumerated together in a corresponding one of the phrases. As used herein, such terms as "1st" and "2nd," or "first" and "second" may be used to simply distinguish a corresponding component from another, and does not limit the components in other aspect (e.g., importance or order). It is to be understood that if an element (e.g., a first element) is referred to, with or without the term "operatively" or "communicatively", as "coupled with," "coupled to," "connected with," or "connected to" another element (e.g., a second element), it means that the element may be coupled with the other element directly (e.g., wiredly), wirelessly, or via a third element.

As used in connection with various embodiments of the disclosure, the term "module" may include a unit implemented in hardware, software, or firmware, and may interchangeably be used with other terms, for example, "logic," "logic block," "part," or "circuitry". A module may be a single integral component, or a minimum unit or part thereof, adapted to perform one or more functions. For example, according to an embodiment, the module may be implemented in a form of an application-specific integrated circuit (ASIC).

Various embodiments as set forth herein may be implemented as software (e.g., the program 140) including one or more instructions that are stored in a storage medium (e.g., internal memory 136 or external memory 138) that is readable by a machine (e.g., the electronic device 101). For example, a processor (e.g., the processor 120) of the machine (e.g., the electronic device 101) may invoke at least one of the one or more instructions stored in the storage medium, and execute it, with or without using one or more other components under the control of the processor. This allows the machine to be operated to perform at least one function according to the at least one instruction invoked. The one or more instructions may include a code generated by a compiler or a code executable by an interpreter. The machine-readable storage medium may be provided in the form of a non-transitory storage medium. Wherein, the term "non-transitory" simply means that the storage medium is a tangible device, and does not include a signal (e.g., an electromagnetic wave), but this term does not differentiate between where data is semi-permanently stored in the storage medium and where the data is temporarily stored in the storage medium.

According to an embodiment, a method according to various embodiments of the disclosure may be included and provided in a computer program product. The computer program product may be traded as a product between a seller and a buyer. The computer program product may be distributed in the form of a machine-readable storage medium (e.g., compact disc read only memory (CD-ROM)), or be distributed (e.g., downloaded or uploaded) online via an application store (e.g., PlayStoreTM), or between two user devices (e.g., smart phones) directly. If distributed online, at least part of the computer program product may be temporarily generated or at least temporarily stored in the machine-readable storage medium, such as memory of the manufacturer's server, a server of the application store, or a relay server.

According to various embodiments, each component (e.g., a module or a program) of the above-described components may include a single entity or multiple entities, and some of the multiple entities may be separately disposed in different components. According to various embodiments, one or more of the above-described components may be omitted, or one or more other components may be added. Alternatively or additionally, a plurality of components (e.g., modules or programs) may be integrated into a single component. In such a case, according to various embodiments, the integrated component may still perform one or more functions of each of the plurality of components in the same or similar manner as they are performed by a corresponding one of the plurality of components before the integration. According to various embodiments, operations performed by the module, the program, or another component may be carried out sequentially, in parallel, repeatedly, or heuristically, or one or more of the operations may be executed in a different order or omitted, or one or more other operations may be added.

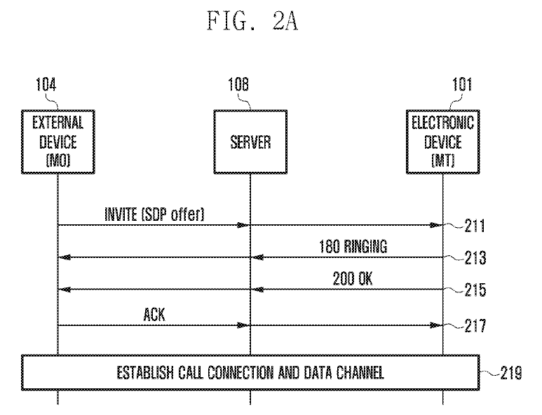

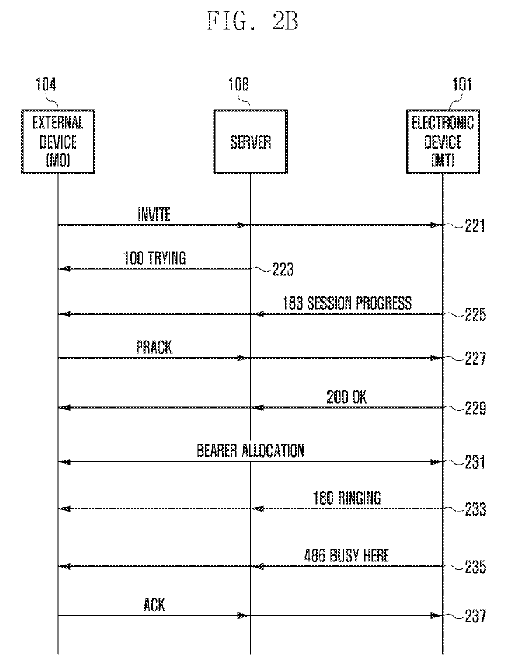

FIG. 2A illustrates a process in which an electronic device in a network environment according to a comparative embodiment establishes a call connection with an external device.

According to various embodiments with reference to FIG. 2A, an electronic device 101 may receive, from an external device 104, a request message (e.g., invite) related to call connection. Hereinafter, the electronic device 101 may include a receiving terminal (or mobile terminated (MT)). The external device 104 may include a sending terminal (or mobile oriented (MO)).

The request message (e.g., invite) related to call connection may be transmitted to the electronic device 101 through a server 108 (operation 211). The electronic device 101 may include an IMS layer supporting an Internet protocol (IP) multimedia subsystem (IMS) function. For example, a request signal (e.g., invite message) related to call connection may include information (e.g., application) related to a call function with the external device 104. As an example, a call connection event may be generated based on at least one of execution of an application program or function related to a call, an input related to call connection, reception of a signal related to call connection, or acquisition of movement information related to call connection. IP multimedia subsystem (IMS) may refer to an architecture for providing various multimedia services such as voice, video, and messages in an Internet protocol (IP) network. The architecture may refer to rules for how components (e.g., MO, MT, and network server) of a communication system interact with each other. The IMS may provide not only voice calls but also video calls, message transmission, and multimedia content sharing functions.

Session description protocol (SDP) may refer to a protocol for determining a media type related to a multimedia session between terminals. The SDP may operate in a structure of offer & answer. An SDP offer may include a request signal (e.g., invite message) related to call connection. An SDP answer may include information related to a ringback tone (e.g., 180 ringing) or information related to acceptance of call connection (e.g., 200 ok).

According to various embodiments, the electronic device 101 may transmit information related to a ringback tone (e.g., 180 ringing) to the external device 104 through the server 108 based on reception of the request signal related to call connection (operation 213). As an example, the ringback tone may refer to a signal tone played until the electronic device 101 accepts or rejects the call connection with the external device 104.

According to various embodiments, the electronic device 101 may transmit information related to acceptance of call connection (e.g., 200 ok) to the external device 104 through the server 108 based on the acceptance of the call connection (operation 215).

According to various embodiments, the external device 104 may transmit a response signal (e.g., ACK) for the information related to the acceptance of the call connection received from the electronic device 101 to the electronic device 101 through the server 108 (operation 217).

According to various embodiments, the electronic device 101 and the external device 104 are connected in a call based on the information related to the acceptance of the call connection and the response signal, and a data channel with the server 108 may be established (operation 219). As an example, the data channel may include an IMS data channel established between the electronic device 101 and the external device 104 and the server 108. As an example, the call connection of the electronic device 101 and the external device 104 may include a call connection (e.g., VoLTE or VoNR) based on a long term evolution (LTE) communication scheme or a new radio (NR) communication scheme.

FIG. 2B illustrates a process in which an electronic device in a network environment according to a comparative embodiment blocks a call connection with an external device.

According to various embodiments with reference to FIG. 2B, an electronic device 101 may receive, from an external device 104, a request signal (e.g., invite message) related to call connection. The request signal (e.g., invite message) related to call connection may be transmitted to the electronic device 101 through a server 108 (operation 221). The electronic device 101 may include an IMS layer supporting an Internet protocol (IP) multimedia subsystem (IMS) function.

According to an embodiment, the server 108 may transmit a message (e.g., 100 trying) indicating that a call request is being processed to the external device 104 (operation 223). The electronic device 101 may transmit a message (e.g., 183 session progress) indicating that a media stream has been started in a corresponding session through the server 108 (operation 225).

According to an embodiment, the external device 104 receives the message (e.g., 183 Session Progress) indicating that the media stream has been started, and may transmit an acknowledgment for the received message to the electronic device 101. The external device 104 may transmit a message (e.g., provisional response acknowledgement (PRACK)) related to the acknowledgment to the electronic device 101 (operation 227). Provisional response acknowledgement (PRACK) may be used to send an identification for a provisional response (e.g., 180 ringing or 183 session progress) in SIP communication.

According to an embodiment, based on receiving the message (e.g., PRACK) related to the acknowledgment, the electronic device 101 may transmit a message (e.g., 200 ok) indicating that the call request has been successfully received to the external device 104 through the server 108 (operation 229).

According to an embodiment, the electronic device 101 may request bearer allocation for a call with the external device 104 on the server 108 (operation 231). The electronic device 101 may request allocation of a dedicated bearer on the server 108. The dedicated bearer, unlike a default bearer, may be individually established for a specific service or application. For example, the server 104 may establish the dedicated bearer for a real-time application such as voice over IP (VoIP) or video streaming. Since real-time applications such as voice over IP (VoIP) or video streaming are sensitive to delay time (or latency) or packet loss, requirements may be satisfied through the dedicated bearer.

According to an embodiment, based on the bearer being allocated, the electronic device 101 may transmit a message (e.g., 180 ringing) indicating that a phone is ringing on the external device 104 (operation 233).

According to an embodiment, based on a number of the external device 104 being included on a blocked number list, the electronic device 101 may transmit a message (e.g., 486 busy here) indicating that call reception has not been achieved to the external device 104 (operation 235). The external device 104 receives the message (e.g., 486 busy here) indicating that the call reception has not been achieved, and may transmit a message (e.g., ACK) indicating that it has been received to the electronic device 101 (operation 237).

Operation 221 to operation 237 may be performed between the electronic device 101, the external device 104, and the server 108. In this process, in a case where the number of the external device 104 is a blocked number, operations 225, 227, 229, 231, and 233 may be unnecessary. Even in a case where the number of the external device 104 is the blocked number, the electronic device 101 may perform operations 225, 227, 229, 231, and 233 for call waiting because it is difficult to identify in advance whether it is the blocked number. In a case where operations 225, 227, 229, 231, and 233 are performed for waiting for a call to be rejected, unnecessary resource waste may occur in the electronic device 101 and the server 108.

The electronic device 101 and the method according to the present document, in a case where the number of the external device 104 for which call connection is requested is included in a blocked number list, may control operations 225, 227, 229, 231, and 233 not to be performed. The electronic device 101 according to the present document identifies in advance at the IMS layer of the electronic device 101 whether the number of the external device 104 for which call connection is requested is included in the blocked number list, and may control preliminary operations (e.g., operations 225, 227, 229, 231, and 233) for call connection not to be performed.

According to an embodiment, the electronic device 101 controls the preliminary operations (e.g., operations 225, 227, 229, 231, and 233) for call connection not to be performed, and thus resources of the electronic device 101 and the server 108 may be saved. Hereinafter, an operation of the electronic device 101 for saving resources will be described.

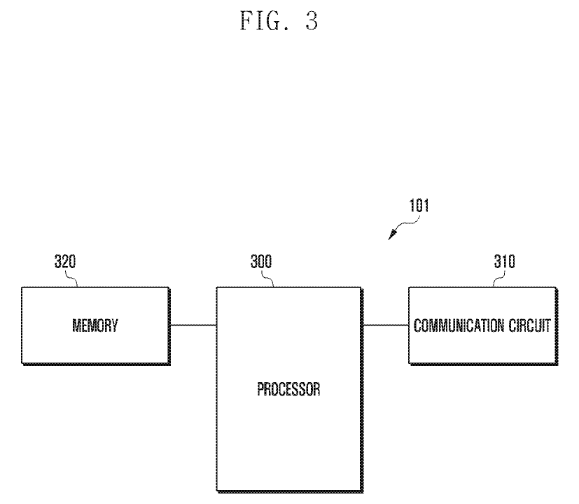

FIG. 3 illustrates a configuration of an electronic device according to an embodiment as a block diagram.

According to various embodiments with reference to FIG. 3, the electronic device 101 may include a processor 300, a communication circuit 310, and/or a memory 320. According to an embodiment, the processor 300 may be substantially the same as the processor 120 of FIG. 1, or may be included in the processor 120. The communication circuit 310 may be substantially the same as the wireless communication module 192 of FIG. 1, or may be included in the wireless communication module 192. The memory 320 may be substantially the same as the memory 130 of FIG. 1, or may be included in the memory 130.

According to an embodiment, the processor 300 may control the communication circuit 310 and/or the memory 320 operatively, functionally, and/or electrically connected. According to an embodiment, the processor 300 may include an application processor (AP) (e.g., the main processor 121 of FIG. 1) and/or a communication processor (CP) (e.g., the auxiliary processor 123 or the communication module 190 of FIG. 1).

According to an embodiment, the processor 300 may control the communication circuit 310 to establish a call connection and a data channel with an external device 104. The processor 300, in a case where occurrence of a call connection event related to the external device 104 is detected, may control the communication circuit 310 to connect a call with the external device 104 through a server 108.

According to an embodiment, the processor 300 may control the communication circuit 310 to transmit and/or receive information (or data) related to an application program through a data channel with the external device 104 in a state in which a call between the electronic device 101 and the external device 104 is connected.

According to an embodiment, the memory 320 may store various data used by at least one component (e.g., the processor 300 and/or the communication circuit 310) of the electronic device 101. As an example, the data may include status information related to an application program. According to an embodiment, the memory 320 may store instructions that may be executed through the processor 300.

According to an embodiment, the electronic device 101 may support an Internet protocol (IP) multimedia subsystem (IMS) function.

According to an embodiment, the electronic device 101 may include the memory 320. The memory 320 may store instructions. The instructions may be executed by the processor 300. The instructions, when executed by the processor 300, may control the electronic device 101 to perform operations as follows.

According to an embodiment, the electronic device 101 may identify a number of an incoming call based on reception of a message for incoming call from an external device. The electronic device 101 may control the IMS layer to acquire a blocked number list stored in the memory 320. The electronic device 101 may control the IMS layer to identify whether the number of the incoming call is included in the blocked number list. The electronic device 101, based on the number of the incoming call being included in the blocked number list, may transmit a message rejecting incoming call to the external device in a state in which operations for preparing establishment of a call connection are not performed. The operations for preparing establishment of a call connection may include, for example, operations 225, 227, 229, 231, and 233 of FIG. 2B. Hereinafter, the processor 300 is a part of components of the electronic device 101, and it may be understood that operations of the processor 300 are performed by the electronic device 101.

According to an embodiment, the processor 300 (or the electronic device 101) may transmit information on the incoming call to an application related to the call and transmit a message rejecting incoming call to the external device based on an instruction of the application. The processor 300 may not request allocation of a bearer for exchanging data with the external device in a situation of preparing to transmit the message rejecting incoming call to the external device. A bearer may refer to a communication channel for being guaranteed quality of service (QoS). The bearer may be allocated by a network or the server 108 in which a communication connection is established. The processor 300 may connect a session to a specific network resource by using the bearer. Here, the session may include a session used when the application of the electronic device 101 transmits traffic (e.g., IP flow). The processor 300 may maintain quality of service including at least any one of bandwidth, delay time, or packet loss by using the bearer.

According to an embodiment, the processor 300 may control a message indicating session progress and a message indicating that the electronic device is ringing not to be transmitted in a situation of preparing to transmit the message rejecting incoming call to the external device.

According to an embodiment, the processor 300 may transmit the message rejecting incoming call to the external device based on the number of the incoming call being included in the blocked number list, and may transmit a message indicating that the incoming call of the external device is rejected to the application.

According to an embodiment, the processor 300 may identify the number of the incoming call by parsing a header of a session initiation protocol (SIP) message. Session initiation protocol (SIP) is a protocol used in Internet communication such as voice over IP (VoIP), and may perform a role of initiating, modifying, and terminating a session. The SIP message may be composed of a header and a body. The header is located at a beginning part of the SIP message, and the body may be optionally used. The header may be used in request and response messages. Parsing may refer to a process of interpreting and processing a header field.

The processor 300 may identify the number of the incoming call by parsing the header of the session initiation protocol (SIP) message. The processor 300 may transmit the identified number of the call to the IMS layer. At the IMS layer, it may be identified whether the identified number of the call is a blocked number. At the IMS layer, information on the blocked number may be acquired from the memory 320 or a database (DB) related to a call. At the IMS layer, based on the identified number of the call being the blocked number, the message rejecting incoming call may be transmitted to the external device in a state in which operations for preparing establishment of a call connection are not performed.

According to an embodiment, the processor 300, based on rejection of the incoming call of the external device, may display a notification indicating that there is the incoming call from the blocked number and the incoming call is automatically rejected on a display.

According to an embodiment, the processor 300 transmits the blocked number list stored in the memory 320 to the IMS layer, and based on the IMS layer being not able to access the blocked number list stored in the memory, may transmit information on the incoming call to the application related to the call.

According to an embodiment, the processor 300, based on the number of the incoming call not being included in the blocked number list, may transmit information on the incoming call to the application, and may request allocation of a bearer for exchanging data with the external device.

According to an embodiment, the processor 300, in a case where the number of the incoming call is included in the blocked number list, may deliver a fact that the call has been received to the application related to the call. In a case where the number of the incoming call is the blocked number, the IMS layer may deliver related information to the application related to the call according to a setting. The related information may include information indicating that the number of the incoming call is the blocked number. Alternatively, at the IMS layer, the call of the external device may be rejected without notifying the application related to the call according to a setting.

In a case where it is set to deliver the related fact to the application related to the call, the IMS layer may wait for a response of the application related to the call in a state in which operations for preparing establishment of a call connection are not performed. In a case where it is set that the related fact does not need to be delivered to the application related to the call, the IMS layer, based on receiving a message rejecting incoming call from the application related to the call, may transmit the message rejecting incoming call to the external device from which the call is originated.

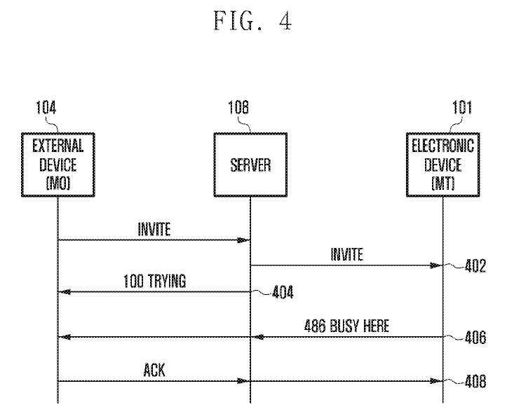

FIG. 4 illustrates a process in which an electronic device according to various embodiments of the present document blocks a call connection with an external device.

A system for call connection may include an electronic device 101, an external device 104, and a server 108. The electronic device 101 has been described in FIG. 1, and may include a receiving terminal (or mobile terminated (MT)). The external device 104 may include a sending terminal (or mobile oriented (MO)). The server 108 may include a server of an application related to call connection.

According to FIG. 4, the electronic device 101 may receive a message (e.g., invite) for a call connection request originated from the external device 104 through the server 108 (operation 402). The server 108 receives the message (e.g., invite) for the call connection request from the external device 108, and may transmit the message (e.g., invite) for the call connection request to the electronic device 101. In addition, the server 108 may transmit a message (e.g., 100 trying) indicating that a call request is being processed to the external device 104 (operation 404).

Unlike FIG. 2B according to the comparative embodiment, the electronic device 101 of FIG. 4 may identify whether a number of an incoming call is a blocked number at an IP multimedia subsystem (IMS) layer.

According to an embodiment, the electronic device 101 may identify the number of the incoming call, and acquire information on the blocked number from a memory (e.g., the memory 320 of FIG. 3 or the memory 130 of FIG. 1).

According to an embodiment, the electronic device 101 may determine to reject reception based on the number of the incoming call being identified as the blocked number. The electronic device 101, based on determining to reject the reception, may transmit a related message (e.g., 486 busy here) to the external device 104 (operation 406).

Since the electronic device according to the comparative embodiment of FIG. 2B cannot identify whether the number of the incoming call is the blocked number, there is a limitation in which operations 225, 227, 229, 231, and 233 are performed in advance. On the other hand, the electronic device 101 according to various embodiments of the present document identifies in advance whether the number of the incoming call is the blocked number, and may wait without performing operations 225, 227, 229, 231, and 233 in a situation of waiting for a response of the server 108. The electronic device 101 may not waste resources in a case of waiting without performing operations 225, 227, 229, 231, and 233. Since the electronic device 101 does not request allocation of a bearer to the server 108, resources of the server 108 may also be saved.

Specifically, the electronic device 101 according to various embodiments of the present document, in a case where the number of the incoming call is identified to be the blocked number, may not transmit a message (e.g., 183 session progress) indicating that a media stream has been started (operation 225 of FIG. 2B). The external device 104, in a case where the message (e.g., 183 session progress) indicating that the media stream has been started is not received, may not transmit a message (e.g., PRACK) related to an acknowledgment (operation 227 of FIG. 2B). The electronic device 101, in a case of not receiving the message related to the acknowledgment, may not transmit a message (e.g., 200 ok) indicating that the call request has been successfully received (operation 229 of FIG. 2B).

In addition, the electronic device 101, in a case where the number of the incoming call is identified to be the blocked number, may not request bearer allocation to the server 108 (operation 231 of FIG. 2B). The electronic device 101, in a case where the number of the incoming call is identified to be the blocked number, may not transmit a message (e.g., 180 ringing) indicating that a phone is ringing on the external device 104 (operation 233 of FIG. 2B). In this way, the electronic device 101 controls operations 225, 227, 229, 231, and 233 not to be executed, and thus may save resources of the electronic device 101 and the server 108.

According to an embodiment, based on a number of the external device 104 being included on a blocked number list, the electronic device 101 may transmit a message (e.g., 486 busy here) indicating that call reception has not been achieved to the external device 104 (operation 406). The external device 104 receives the message (e.g., 486 busy here) indicating that the call reception has not been achieved, and may transmit a message (e.g., ACK) indicating that it has been received to the electronic device 101 (operation 408).

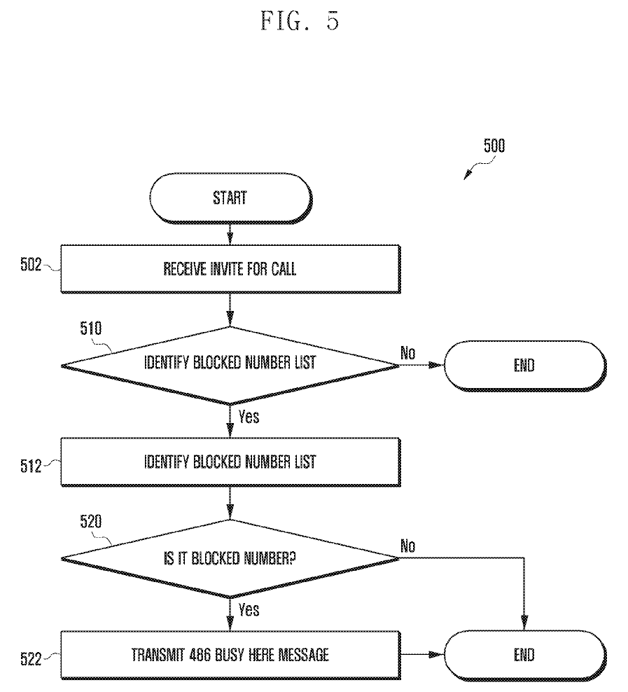

FIG. 5 illustrates a method in which an electronic device according to an embodiment blocks a call connection with an external device as a flowchart.

The operations described through FIG. 5 may be implemented based on instructions that may be stored in a computer recording medium or a memory (e.g., the memory 130 of FIG. 1). The illustrated method 500 may be executed by the electronic device (e.g., the electronic device 101 of FIG. 1) described above through FIGS. 1-4, and technical features described above will be omitted hereinafter. An order of each operation of FIG. 5 may be changed, some operations may be omitted, and some operations may be performed simultaneously.

In operation 502 of FIG. 5, the electronic device 101 may receive a request message (e.g., invite) for a call or call connection.

In operation 510 of FIG. 5, the electronic device 101 may identify whether the received request message (e.g., invite) is for a call. The request message (e.g., invite) may include, for example, an initiation request for any one of a text, a video, or a call. The electronic device 101 may identify whether it is a request message for a call among the text, the video, or the call. The electronic device 101 may terminate the process of FIG. 5 in a case where it is not the request message for the call.

In operation 512 of FIG. 5, based on the received message being identified as the request message for the call, the electronic device 101 may identify a blocked number list. Information on the blocked number may be in a state of being stored in the memory 130. The electronic device 101 may acquire the information or the list for the blocked number stored in the memory 130 and transmit it to an IMS layer.

In operation 520, the electronic device 101 may identify whether a number of the incoming call is a blocked number. The electronic device 101 may compare the number of the incoming call with the blocked number list stored in the memory 130.

According to an embodiment, based on the number of the incoming call not being the blocked number, the electronic device 101 may perform operations mentioned in FIG. 2A (e.g., operation 213 and operation 215 of FIG. 2A) to establish a call connection. The electronic device 101 may terminate the operation of FIG. 5 in a case where the number of the incoming call is not the blocked number.

In operation 522, based on the number of the incoming call being the blocked number, the electronic device 101 may transmit a message (e.g., 486 busy here) indicating that call reception has not been achieved to an external device (e.g., the external device 104 of FIG. 4). The electronic device 101 may transmit the message (e.g., 486 busy here) indicating that the call reception has not been achieved and terminate the operation of FIG. 5.

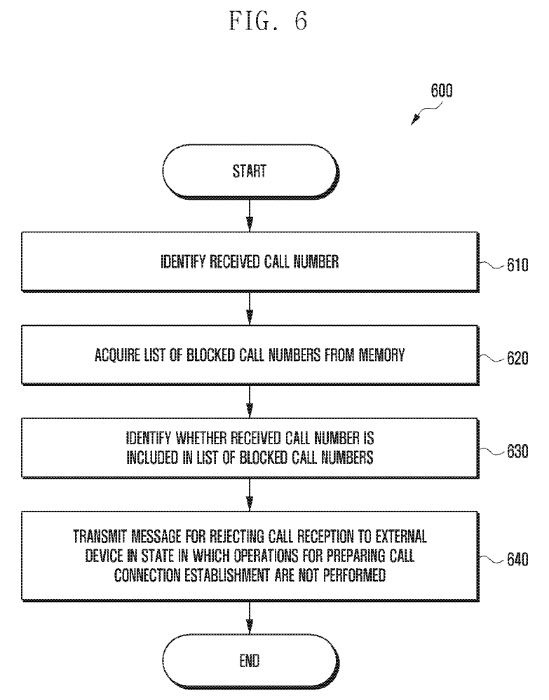

FIG. 6 illustrates an operation in which an electronic device according to an embodiment blocks a call connection with an external device as a flowchart.

The operations described through FIG. 6 may be implemented based on instructions that may be stored in a computer recording medium or a memory (e.g., the memory 130 of FIG. 1). The illustrated method 600 may be executed by the electronic device (e.g., the electronic device 101 of FIG. 1) described above through FIGS. 1-4, and technical features described above will be omitted hereinafter. An order of each operation of FIG. 6 may be changed, some operations may be omitted, and some operations may be performed simultaneously.

In operation 610, the electronic device 101 may identify a number of an incoming call. The processor may identify the number of the incoming call by parsing a header of a session initiation protocol (SIP) message.

In operation 620, the electronic device 101 may load a blocked number list on the memory 130. At an IP multimedia subsystem (IMS) layer of the electronic device 101, the blocked number list may be acquired. The blocked number may be input by a user and stored in the memory 130.

In operation 630, the electronic device 101 may identify whether the number of the incoming call is included in the blocked number list. The operation of identifying the blocked number list may be performed at the IP multimedia subsystem (IMS) layer of the electronic device 101.

In operation 640, the electronic device 101 may transmit a message rejecting incoming call (e.g., 486 reject) to the external device in a state in which operations for preparing establishment of a call connection are not performed. The operations for preparing establishment of a call connection may include, for example, 100Trying, 183 Session Progress, and 180 Ringing. In addition, the operations for preparing establishment of a call connection may include a bearer allocation operation. A bearer may refer to a communication channel of session initiation protocol (SIP). The bearer may be used to maintain quality of service of a data stream by connecting a data session of the user with a specific network resource. The quality of service may include, for example, any one of a fixed bandwidth, a delay time, or a packet loss. The message rejecting incoming call (e.g., 486 reject) may be one of SIP response codes. The message rejecting incoming call may be used to deliver that it is a situation in which a call cannot be received.

According to an embodiment, based on the number of the incoming call being included in the blocked number list, the processor 300 may transmit the message rejecting incoming call to the external device, and may transmit a message indicating that the incoming call of the external device is rejected to an application.

The processor 300, based on rejection of the incoming call of the external device, may display a notification indicating that there is the incoming call from the blocked number and the incoming call is automatically rejected on a display.

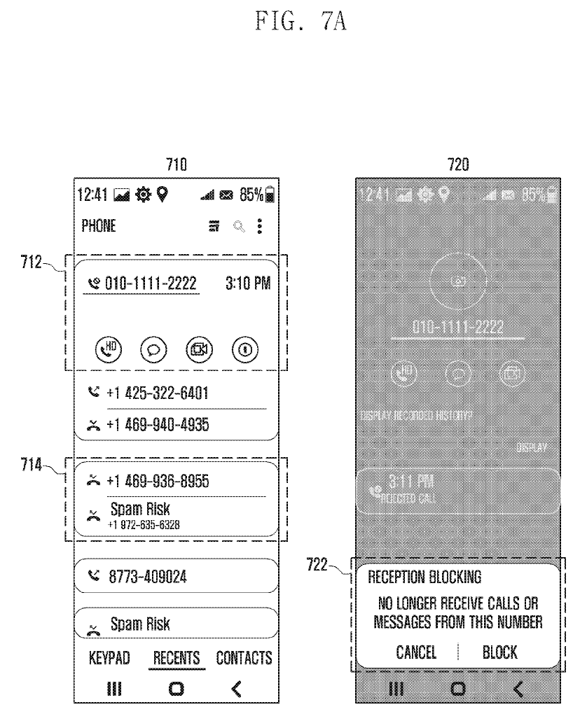

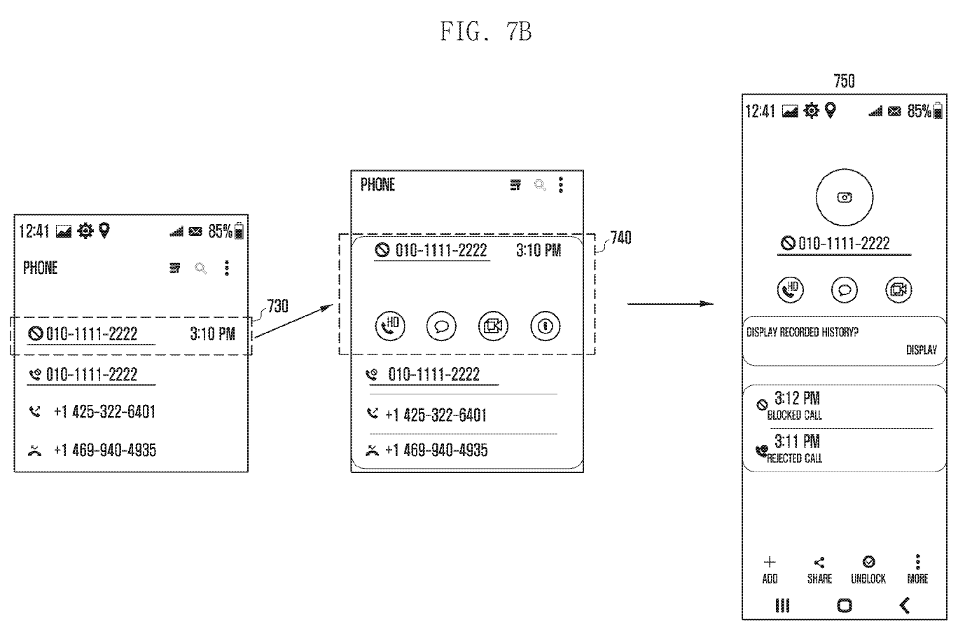

FIGS. 7A and 7B illustrate an embodiment in which an electronic device according to an embodiment blocks a call connection with an external device and displays it to a user of the electronic device.

In view 710 of FIG. 7A, a processor (e.g., the processor 300 of FIG. 3), in a case where there is an incoming call from an external device and it is rejected, may display an indicator 712 indicating that the incoming call is rejected.

In view 714, the processor 300, based on rejection of the incoming call of the external device, may display a notification indicating that there is the incoming call from a blocked number and the incoming call is automatically rejected on a display.

In view 720, the processor 300 may display a record of when the rejected call is received based on a user input on the indicator 712 for the rejected call. In addition, the processor 300 may display an indicator 722 asking whether to continue to reject reception for the rejected call in the future. The processor 300 may store a number of the rejected call on a blocked number list based on a user input on the indicator 722 asking whether to continue to reject reception in the future.

According to an embodiment, the processor 300, in a case where the number of the incoming call is included in the blocked number list, may deliver a fact that the call has been received to the application related to the call. In a case where the number of the incoming call is the blocked number, the IMS layer may deliver related information to the application related to the call according to a setting. The related information may include information indicating that the number of the incoming call is the blocked number. Alternatively, at the IMS layer, the call of the external device may be rejected without notifying the application related to the call according to a setting.

In a case where it is set to deliver the related fact to the application related to the call, the IMS layer may wait for a response of the application related to the call in a state in which operations for preparing establishment of a call connection are not performed. In a case where it is set that the related fact does not need to be delivered to the application related to the call, the IMS layer, based on receiving a message rejecting incoming call from the application related to the call, may transmit the message rejecting incoming call to the external device from which the call is originated.

In FIG. 7B, the processor 300 may display an indicator 730 indicating that a specific number has been blocked from reception. In view 740, the processor 300 may display information indicating that the specific number has been blocked based on a user input for the indicator 730. In view 750, the processor 300 may display information on when a call is received from the blocked number and when it is registered as the blocked number based on a user input for view 740.

According to an embodiment, the processor 300 may reject the incoming call from the blocked number according to a user setting, and might not display a notification indicating that the incoming call is automatically rejected. Alternatively, the processor 300 may display the incoming call from the blocked number according to the user setting, and display an indicator emphasizing that it is the blocked number on the display. The processor 300 may use a notification different from a notification for a general call for the incoming call from the blocked number according to the user setting. The notification may include, for example, a ringtone or a vibration sound in addition to a form of a message.

According to an embodiment, an electronic device may include a processor and a memory storing instructions. The instructions, when executed by the processor, may cause the electronic device to store a blocked number list, to identify a phone number related to a first message based on reception of the first message for an incoming call, to identify whether the phone number related to the first message is included in the blocked number list, and to transmit a second message rejecting the incoming call to an external device in a state in which at least any one operation among operations for a call connection is not performed, based on the phone number related to the first message being included in the blocked number list.

According to an embodiment, the first message includes a session initiation protocol (SIP) message, and the second message may be transmitted in a state in which a bearer is not allocated.

According to an embodiment, the electronic device performs an operation of identifying the phone number related to the first message at an IP multimedia subsystem (IMS) layer and identifying whether the phone number related to the first message is included in the blocked number list, and the operations for call connection may include any one of a message indicating bearer allocation, a message indicating session progress, or a message indicating that the electronic device is ringing.

According to an embodiment, the electronic device, based on the number of the incoming call being included in the blocked number list, may transmit a message rejecting incoming call to the external device, and transmit a message indicating that the incoming call of the external device is rejected to an application related to the call.

According to an embodiment, the electronic device, based on rejection of the incoming call of the external device, may display a notification indicating that there is the incoming call from the blocked number and the incoming call is automatically rejected on the display.

According to an embodiment, the electronic device transmits the blocked number list stored in the memory to the IMS layer, and based on the IMS layer being not able to access the blocked number list stored in the memory, may transmit information on the incoming call to the application related to the call. “Based on” as used herein covers based at least on.

In an operating method, the operating method may include an operation of storing a blocked number list, an operation of identifying a phone number related to a first message based on reception of the first message for an incoming call, an operation of identifying whether the phone number related to the first message is included in the blocked number list, and an operation of transmitting a second message rejecting the incoming call to an external device in a state in which at least any one operation among operations for a call connection is not performed, based on the phone number related to the first message being included in the blocked number list.

A storage medium includes a processor and a memory in which a blocked number list is stored, the memory stores instructions, and the instructions, when executed by the processor, may cause the electronic device to store the blocked number list, to identify a phone number related to a first message based on reception of the first message for an incoming call, to identify whether the phone number related to the first message is included in the blocked number list, and to transmit a second message rejecting the incoming call to an external device in a state in which at least any one operation among operations for call connection is not performed, based on the phone number related to the first message being included in the blocked number list.

1. An electronic device comprising:
at least one processor comprising processing circuitry; and
a memory configured to store a blocked number list,
wherein the memory is configured to store instructions that, when executed individually and/or collectively by the at least one processor, cause the electronic device to:
identify a number of an incoming call, based on reception of a message for the incoming call from an external device;
control an IMS layer to acquire the blocked number list stored in the memory;
control the IMS layer to identify whether the number of the incoming call is included in the blocked number list; and
control to transmit a message rejecting the incoming call to the external device in a state in which operations for preparing establishment of a call connection are not performed based on the number of the incoming call being not included in the blocked number list.

2. The electronic device of claim 1, wherein the at least one processor is individually and/or collectively configured to:
control to transmit the message rejecting the incoming call to the external device, based on an indication of the application; and
in a ready state for transmitting the message rejecting the incoming call to the external device,
perform control to not allocate a bearer for exchanging the message with the external device.

3. The electronic device of claim 1, wherein the at least one processor is individually and/or collectively configured to:
in a ready state for transmitting the message rejecting the incoming call to the external device,
perform control to not transmit a message indicating session progress and a message indicating that the electronic device is ringing.

4. The electronic device of claim 1, wherein the at least one processor is individually and/or collectively configured to:
control to transmit the message rejecting the incoming call to the external device, based on the number of the incoming call being included in the blocked number list; and
control to transmit a message indicating that the incoming call of the external device is rejected to the application.

5. The electronic device of claim 1, wherein the at least one processor is individually and/or collectively configured to parse a header of a session initiation protocol (SIP) message and identify the number of the incoming call.

6. The electronic device of claim 1, wherein the at least one processor is individually and/or collectively configured to, based on rejection of the incoming call of the external device, control to display a notification indicating that there is the incoming call from a blocked number and that the incoming call is automatically rejected.

7. The electronic device of claim 1, wherein the at least one processor is individually and/or collectively configured to:
control to transmit the blocked number list stored in the memory to the IMS layer; and
control to transmit information on the incoming call to the application related to the call, based on the IMS layer being not able to access the blocked number list stored in the memory.

8. The electronic device of claim 1, wherein the at least one processor is individually and/or collectively configured to:
transmit information on the incoming call to the application, based on the number of the incoming call being not included in the blocked number list; and
allocate a bearer for exchanging a message with the external device.

9. A method of operating an electronic device, the method comprising:
storing a blocked number list;
identifying a phone number related to a first message based on reception of the first message for an incoming call;
identifying whether the phone number related to the first message is included in the blocked number list; and
transmitting a second message rejecting the incoming call to an external device in a state in which at least any one operation among operations for a call connection is not performed, based on the phone number related to the first message being included in the blocked number list.

10. The method of claim 9, wherein the first message comprises a session initiation protocol (SIP) message, and the second message is transmitted in a state in which a bearer is not allocated.

11. The method of claim 9, further comprising:
identifying the phone number related to the first message at an IP multimedia subsystem (IMS) layer; and
identifying whether the phone number related to the first message is included in the blocked number list at the IMS layer,
wherein the operations for the call connection comprise any one of a message indicating bearer allocation, a message indicating session progress, or a message indicating that the electronic device is ringing.

12. The method of claim 9, further comprising:
transmitting a message rejecting the incoming call to the external device based on a number of the incoming call being included in the blocked number list; and
transmitting a message indicating that the incoming call of the external device is rejected to an application related to the call.

13. The method of claim 9, wherein the identifying of the number of the incoming call based on reception of a message for the incoming call from the external device further comprises:
identifying the number of the incoming call by parsing a header of a session initiation protocol (SIP) message.

14. The method of claim 9, further comprising:
displaying a notification indicating that there is the incoming call from a blocked number and that the incoming call is automatically rejected on a display based on rejection of the incoming call of the external device.

15. The method of claim 9, further comprising:
transmitting the blocked number list stored in a memory to an IMS layer; and
transmitting information on the incoming call to an application related to the call based on the IMS layer being not able to access the blocked number list stored in the memory.

16. The method of claim 9, further comprising:
transmitting information on the incoming call to an application related to the call based on a number of an incoming call not being included in the blocked number list; and
requesting allocation of a bearer for exchanging data with the external device to a network.

17. A non-transitory storage medium, comprising:
a memory in which a blocked number list is stored,
wherein the memory stores instructions, and the instructions, when executed individually and/or collectively by a processor, cause the electronic device to:
store a blocked number list;
identify a phone number related to a first message based on reception of the first message for an incoming call;
identify whether the phone number related to the first message is included in the blocked number list; and
transmit a second message rejecting the incoming call to an external device in a state in which at least any one operation among operations for a call connection is not performed, based on the phone number related to the first message being included in the blocked number list.

18. The storage medium of claim 17, wherein the first message comprises a session initiation protocol (SIP) message, and the second message is transmitted in a state in which a bearer is not allocated.

19. The storage medium of claim 17, wherein the memory stores instructions for performing:
identifying the phone number related to the first message at an IP multimedia subsystem (IMS) layer; and
identifying whether the phone number related to the first message is included in the blocked number list, and
wherein the operations for the call connection comprise any one of a message indicating bearer allocation, a message indicating session progress, or a message indicating that the electronic device is ringing.

20. The storage medium of claim 17, wherein the memory stores instructions for:
transmitting a message rejecting the incoming call to the external device based on a number of the incoming call being included in the blocked number list; and
transmitting a message indicating that the incoming call of the external device is rejected to an application related to the call.
